(19) United States
(12) Patent Application Publication
(10) Pub. No.: US 2022/0321494 A1
(43) Pub. Date: Oct. 6, 2022

(54) COMMUNICATION DEVICE, NON-TRANSITORY COMPUTER-READABLE RECORDING MEDIUM, AND COMMUNICATION SYSTEM

(71) Applicant: WOVEN PLANET HOLDINGS, INC., Tokyo (JP)

(72) Inventors: Toshinobu WATANABE, Tokyo-to (JP); Ryokichi ONISHI, Tokyo-to (JP)

(73) Assignee: WOVEN PLANET HOLDINGS, INC., Tokyo (JP)

(21) Appl. No.: 17/712,217

(22) Filed: Apr. 4, 2022

(30) Foreign Application Priority Data
Apr. 6, 2021 (JP) 2021-064860

(51) Int. Cl. H04L 47/6275; H04L 47/62

(52) U.S. Cl. CPC H04L 47/6275; H04L 47/6215; H04L 47/622

(57) ABSTRACT

A communication device installed on a moving body includes: multiple types of communication interfaces configured to perform communications based on multiple types of communication methods, respectively; multiple types of queues associated with the multiple types of communication interfaces, respectively; and a communication controller provided between at least one application and the multiple types of queues. Each communication interface is configured to transmit a packet stored in an associated queue among the multiple types of queues to an external device. The communication controller is configured to: receive a transmission packet to be transmitted to the external device from the at least one application; identify a communication requirement for each transmission packet; select at least one selection queue for each transmission packet among the multiple types of queues according to the communication requirement; and store the transmission packet in the at least one selection queue.

### CROSS-REFERENCE TO RELATED APPLICATION

This application claims priority to Japanese Patent Application No. 2021-064860 filed on Apr. 6, 2021, the entire contents of which are incorporated by reference herein.

### BACKGROUND

### Technical Field

The present disclosure relates to a communication technique applied to a moving body.

### Background Art

Patent Literature 1 discloses an in-vehicle communication device. The in-vehicle communication device supports both a mobile communication method and a WiFi communication method. When an abnormality of the vehicle is detected, the in-vehicle communication device transmits numerical data and image data indicating a vehicle travel status to a specified server. At this time, the in-vehicle communication device transmits the numerical data by the mobile communication method and transmits the image data by the WiFi communication method.

Patent Literature 2 discloses an in-vehicle cloudlet that performs a wireless communication with a communication node. The in-vehicle cloudlet determines an optimum wireless communication method among multiple wireless communication methods, and transmits and receives data by the use of the optimum wireless communication method.

Patent Literature 3 discloses an information providing device that provides a vehicle with information. The information providing device determines a degree of urgency of transmitting information to the vehicle. When the degree of urgency is high, the information providing device transmits the information by a communication method with a high communication rate.

Patent Literature 4 discloses an in-vehicle communication system that performs a data communication based on a packet switching method or a line switching method. The in-vehicle communication system selects the packet switching method or the line switching method from a viewpoint of reduction in communication rates.

### LIST OF RELATED ART

Patent Literature 1: Japanese Laid-Open Patent Application Publication No. JP-2018-120443

Patent Literature 2: Japanese Laid-Open Patent Application Publication No. JP-2018-170628

Patent Literature 3: Japanese Laid-Open Patent Application Publication No. JP-2007-049543

Patent Literature 4: Japanese Laid-Open Patent Application Publication No. JP-2005-217526

### SUMMARY

A case where an application running on a moving body such as a vehicle and a robot communicates with an external device is considered. It is conceivable that with diversification of applications, communication requirements required by the applications also are diversified. It is also conceivable that a communication requirement differs for each packet even in an identical application. It is therefore desirable to achieve an appropriate communication for each packet according to a communication requirement.

An object of the present disclosure is to provide a technique that can achieve an appropriate communication for each packet according to a communication requirement, in a communication between a moving body and an external device.

A first aspect is directed to a communication device installed on a moving body.

The communication device includes:

multiple types of communication interfaces configured to perform communications based on multiple types of communication methods, respectively;

multiple types of queues associated with the multiple types of communication interfaces, respectively; and

a communication controller provided between at least one application and the multiple types of queues.

each of the multiple types of communication interfaces is configured to transmit a packet stored in an associated queue among the multiple types of queues to an external device.

The communication controller is configured to:

receive a transmission packet to be transmitted to the external device from the at least one application;

identify a communication requirement for each transmission packet;

select at least one selection queue for each transmission packet among the multiple types of queues according to the communication requirement; and

store the transmission packet in the at least one selection queue.

A second aspect further has the following feature in addition to the first aspect.

Each of the multiple types of queues includes a priority queue and a normal queue whose priority is lower than that of the priority queue.

Each of the multiple types of communication interfaces is further configured to:

when the transmission packet is stored in the priority queue, transmit the transmission packet stored in the priority queue; and

when no transmission packet is stored in the priority queue, transmit the transmission packet stored in the normal queue.

A third aspect is directed to communication middleware applied to a communication device installed on a moving body.

The communication device includes:

multiple types of communication interfaces configured to perform communications based on multiple types of communication methods, respectively; and

multiple types of queues associated with the multiple types of communication interfaces, respectively.

Each of the multiple types of communication interfaces is configured to transmit a packet stored in an associated queue among the multiple types of queues to an external device.

The communication middleware is configured to execute, when executed by a computer, a queuing process including:

receiving a transmission packet to be transmitted to the external device from at least one application;

identifying a communication requirement for each transmission packet;

selecting at least one selection queue for each transmission packet among the multiple types of queues according to the communication requirement; and

storing the transmission packet in the at least one selection queue.

A fourth aspect is directed to a communication system.

The communication system includes:

a first communication device installed on a moving body; and

a second communication device connected to the first communication device through a communication network.

The first communication device includes:

multiple types of communication interfaces configured to perform communications based on multiple types of communication methods, respectively;

multiple types of queues associated with the multiple types of communication interfaces, respectively; and

a communication controller provided between at least one application and the multiple types of queues.

Each of the multiple types of communication interfaces is configured to transmit a packet stored in an associated queue among the multiple types of queues to the second communication device.

The communication controller is configured to:

receive a transmission packet to be transmitted to the second communication device from the at least one application;

identify a communication requirement for each transmission packet;

select at least one selection queue for each transmission packet among the multiple types of queues according to the communication requirement; and

store the transmission packet in the at least one selection queue.

According to the first aspect described above, the multiple types of queues associated with the multiple types of communication methods, respectively, are prepared. Then, for each transmission packet, the communication requirement is identified and a queuing process according to the communication requirement is performed. It is thus possible to achieve an appropriate communication for each transmission packet according to the communication requirement.

According to the second aspect described above, the priority queue and the normal queue are provided for each communication method. It is thus possible to simultaneously deal with multiple types of communication requirements by the same communication method without deteriorating a communication efficiency (communication performance).

According to the third and fourth aspects described above, the same effect as in the case of the first aspect is obtained.

### BRIEF DESCRIPTION OF DRAWINGS

FIG. 1 is a conceptual diagram showing an outline of a communication system according to a first embodiment of the present disclosure;

FIG. 2 is a conceptual diagram for explaining an application example of a communication system according to the first embodiment of the present disclosure;

FIG. 3 is a block diagram showing a configuration example of a communication system according to the first embodiment of the present disclosure;

FIG. 4 is a flow chart showing a queuing process by a first communication device according to the first embodiment of the present disclosure;

FIG. 5 is a conceptual diagram for explaining a queuing process in a case where a communication requirement is “standard” according to the first embodiment of the present disclosure;

FIG. 6 is a conceptual diagram for explaining a queuing process in a case where a communication requirement is “low delay” according to the first embodiment of the present disclosure;

FIG. 7 is a conceptual diagram for explaining a queuing process in a case where a communication requirement is “high throughput” according to the first embodiment of the present disclosure;

FIG. 8 is a block diagram showing a concrete example of a communication system according to the first embodiment of the present disclosure;

FIG. 9 is a block diagram showing a configuration example of a communication system according to a second embodiment of the present disclosure;

FIG. 10 is a conceptual diagram for explaining a queuing process in a case where a communication requirement is “standard” according to the second embodiment of the present disclosure;

FIG. 11 is a conceptual diagram for explaining a queuing process in a case where a communication requirement is “low delay” according to the second embodiment of the present disclosure;

FIG. 12 is a conceptual diagram for explaining a queuing process in a case where a communication requirement is “high throughput” according to the second embodiment of the present disclosure;

FIG. 13 is a conceptual diagram for explaining a queuing process in a case where a communication requirement is “low cost” according to the second embodiment of the present disclosure; and

FIG. 14 is a block diagram showing a concrete example of a communication system according to the second embodiment of the present disclosure.

### EMBODIMENTS

Embodiments of the present disclosure will be described with reference to the accompanying drawings.

### 1. First Embodiment

### 1-1. Outline of Communication System

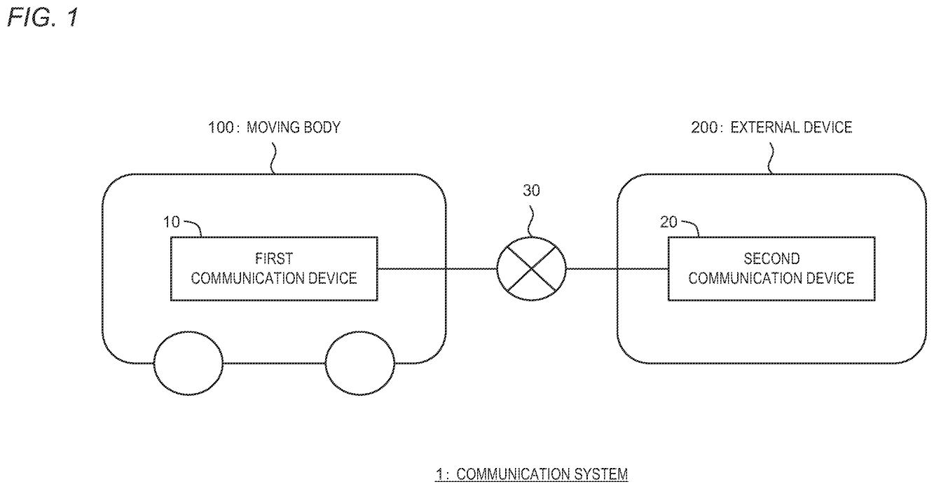

FIG. 1 is a conceptual diagram showing an outline of a communication system 1 according to the present embodiment. The communication system 1 includes a first communication device 10, a second communication device 20, and a communication network 30. The first communication device 10 and the second communication device 20 are connected to each other via the communication network 30. The first communication device 10 and the second communication device 20 is able to communicate with each other via the communication network 30.

In the present embodiment, at least one of the first communication device 10 and the second communication device 20 is installed on a moving body. Examples of the moving body include a vehicle, a robot, a flying object, and the like. The vehicle may be an automated driving vehicle or a vehicle driven by a driver. Examples of the robot include a logistics robot, a work robot, and the like. Examples of the flying object include an airplane, a drone, and the like.

In the following description, the first communication device 10 is installed on a moving body 100. The second communication device 20 is installed on an external device 200 outside the moving body 100. A type of the external device 200 is not limited in particular. For example, the external device 200 is a management server for managing the moving body 100. As another example, the external device 200 may be a remote support device that remotely supports an operation of the moving body 100. As yet another example, the external device 200 may be a moving body different from the moving body 100. Typically, the first communication device 10 of the moving body 100 and the second communication device 20 of the external device 200 performs a wireless communication. However, the present embodiment is not limited to the wireless communication.

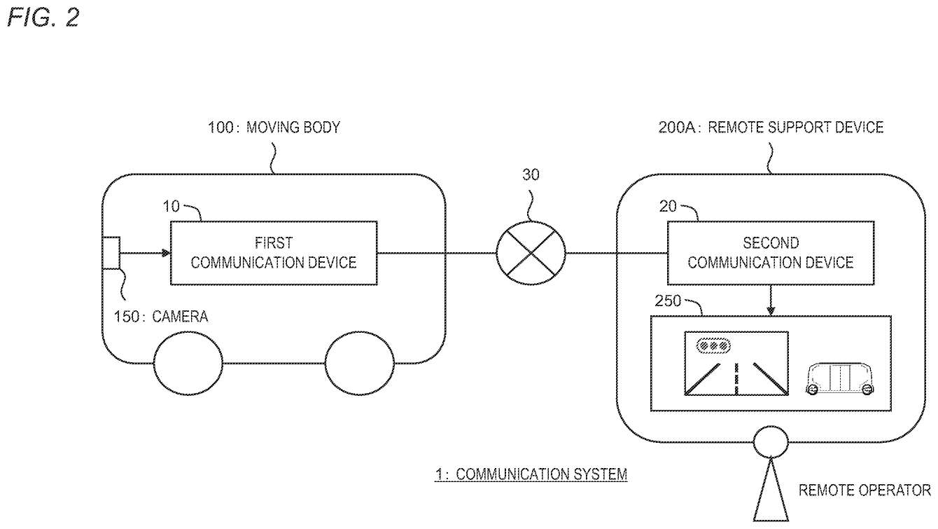

FIG. 2 is a conceptual diagram for explaining an application example of the communication system 1 according to the present embodiment. In the example shown in FIG. 2, the communication system 1 is utilized for “remote support” that remotely supports an operation of the moving body 100. More specifically, a camera 150 is installed on the moving body 100. The camera 150 images a situation around the moving body 100 to acquire image information. The first communication device 10 transmits the image information to a remote support device 200A being an example of the external device 200. The second communication device 20 of the remote support device 200A receives the image information from the moving body 100. The remote support device 200A displays the received image information on a monitor 250. A remote operator looks at the image information displayed on the monitor 250 to grasp the situation around the moving body 100 and remotely support the operation of the moving body 100. Examples of the remote support by the remote operator include recognition support, judgement support, remote driving, and the like. An instruction from the remote operator is transmitted from the second communication device 20 to the first communication device 10 of the moving body 100. The moving body 100 operates according to the instruction from the remote operator.

In such the remote support, real-time capability is important. Therefore, “low delay” is particularly required for the communication between the first communication device 10 and the second communication device 20.

However, a scene in which the moving body 100 requires the communication is not limited only to the remote support. For example, the communication is required when delivering an infotainment service to the moving body 100 (e.g., a vehicle) on which a user rides. As another example, the communication is required when collecting moving body information including sensor information of the moving body 100 and the like. In this manner, the communication with the external device 200 may occur in various scenes.

More specifically, an entity that requests the communication with the external device 200 is an application program (hereinafter simply referred to as an “application” or “app”) running on the moving body 100. It is conceivable that with diversification of applications, communication requirements required by the applications also are diversified. For example, “low delay” may be required in the remote assistance, and “high throughput” may be required in the infotainment service. Moreover, it is also conceivable that the communication requirement differs for each packet even in an identical application. For example, in the scene of the remote support described above, an image in a forward direction of the moving body 100 is more important than an image in a rear direction. Therefore, high image quality (e.g., high resolution, high frame rate) is required for the forward image, and thus “high throughput” is required for transmission of the forward image. On the other hand, an image quality of the rear image is set low in order to reduce a communication amount, and thus the high throughput is not required for transmission of the rear image.

In view of the above, the present embodiment provides a technique for achieving an appropriate communication for each packet according to the communication requirement,

### 1-2. Configuration Example of Communication System

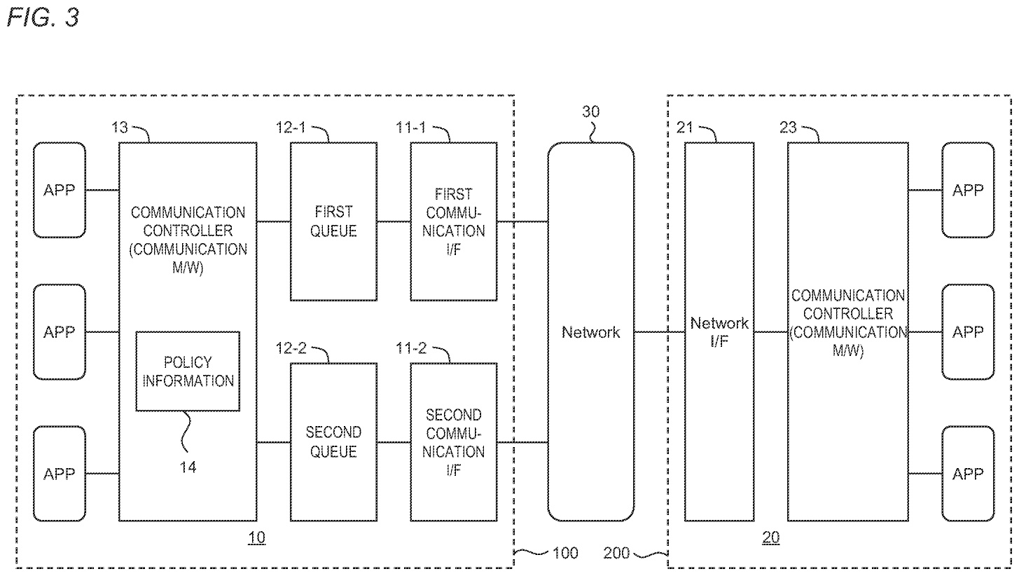

FIG. 3 is a block diagram showing a configuration example of the communication system 1 according to the present embodiment.

The first communication device 10 supports multiple types of communication methods (communication systems, communication protocols). Examples of the communication method include a common cellular method provided by MNO (Mobile Network Operator), an inexpensive cellular method provided by MVNO (Mobile Virtual Network Operator), a wireless LAN (Local Area Network) method, and the like. A communication cost differs among the multiple types of communication methods. In the example above, the wireless LAN method is the lowest and the common cellular method is the highest.

As shown in FIG. 3, the first communication device 10 includes multiple types of communication interfaces 11, multiple types of queues 12, and a communication controller 13.

The multiple types of communication interfaces 11 are connected to the communication network 30 and perform communications with the second communication device 20 based on the multiple types of communication methods, respectively. For example, a first communication interface 11-1 performs a communication based on a first communication method. A second communication interface 11-2 performs a communication based on a second communication method different from the first communication method. It should be noted that the multiple types of communication interfaces 11 may be realized by different physical interfaces, or may be realized by a combination of a common physical interface and different logical interfaces.

The multiple types of queues 12 are provided so as to be associated with the multiple types of communication interfaces 11, respectively. Each queue 12 stores a transmission packet to be transmitted to the external device 200 (i.e., the second communication device 20). Each of the multiple types of communication interfaces 11 reads the transmission packet stored in the associated queue among the multiple types of queues 12 and transmits the read transmission packet to the external device 200. For example, the first queue 12-1 is associated with the first communication interface 11-1 and stores a transmission packet to be transmitted by the first communication method. The first communication interface 11-1 transmits the transmission packet stored in the first queue 12-1. A second queue 12-2 is associated with the second communication interface 11-2 and stores a transmission packet to be transmitted by the second communication method. The second communication interface 11-2 transmits the transmission packet stored in the second queue 12-2. It should be noted that the multiple types of queues 12 are realized by a memory.

The communication controller 13 is provided to control packets transmitted and received by at least one application running on the moving body 100. For example, the communication controller 13 performs a “queuing process” that stores a transmission packet transmitted from the application to the external device 200 (i.e., the second communication device 20) in the queue 12. To that end, the communication controller 13 is provided between at least one application and the multiple types of queues 12. The communication controller 13 receives a transmission packet transmitted from the at least one application to the external device 200. Then, the communication controller 13 stores the transmission packet in an appropriate queue among the multiple types of queues 12. Details of the queuing process will be described later.

The communication controller 13 is realized by, for example, middleware. The middleware that provides functions of the communication controller 13 is hereinafter referred to as “communication middleware.” The moving body 100 is provided with a computer including a processor and a memory. The communication middleware is stored in the memory. The functions of the communication controller 13 are realized by the processor (the computer) executing the communication middleware. It should be noted that the communication middleware may be recorded on a non-transitory computer-readable recording medium. The communication middleware may be provided via a network.

The second communication device 20 includes a network interface 21 and a communication controller 23. The network interface 21 is connected to the communication network 30 and communicates with the first communication device 10.

The communication controller 23 is provided to control packets transmitted and received by at least one application running on the external device 200. To that end, the communication controller 23 is provided between at least one application and the network interface 21. As in the case of the communication controller 13, the communication controller 23 is realized by, for example, communication middleware. The external device 200 is provided with a computer including a processor and a memory. The communication middleware is stored in the memory. The functions of the communication controller 23 are realized by the processor (the computer) executing the communication middleware. It should be noted that the communication middleware may be recorded on a non-transitory computer-readable recording medium. The communication middleware may be provided via a network.

As another example, the second communication device 20 may have the same queue configuration and interface configuration as the first communication device 10.

### 1-3. Communication Processing in Communication System

Processing of packet transmission from the moving body 100 to the external device 200 is as follows. At least one application of the moving body 100 outputs a transmission packet to be transmitted to the external device 200. The communication controller 13 receives the transmission packet from the application and performs the queuing process.

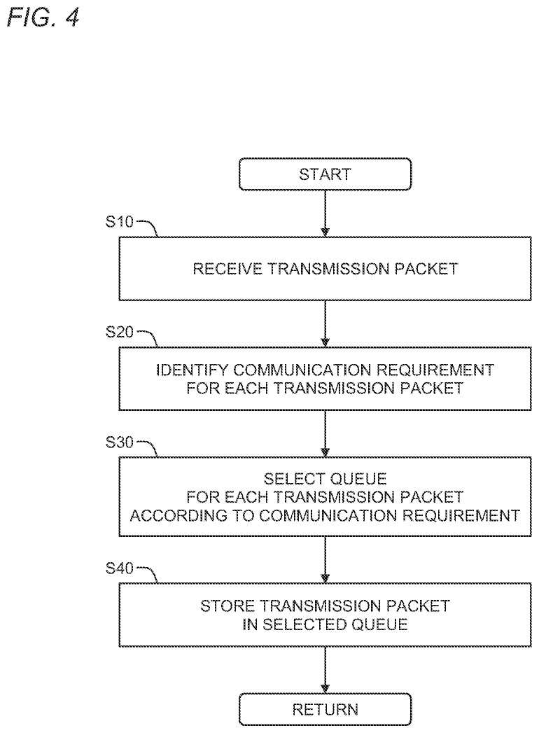

FIG. 4 is a flow chart showing the queuing process according to the present embodiment. In Step S10, the communication controller 13 receives the transmission packet from the application.

In Step S20, the communication controller 13 identifies a communication requirement for each transmission packet received. Examples of the communication requirement include “standard,” “low delay,” “high throughput,” “low cost,” and the like. The “low delay” communication requirement requires a lower communication delay than the “standard” communication requirement. The “high throughput” communication requirement requires a higher throughput than the “standard” communication requirement. The “low cost” communication requirement requires a lower communication cost than the “standard” communication requirement. Typically, the communication requirement is specified by the application.

For example, identification information for identifying the communication requirement is included in a header of the transmission packet. For example, the identification information is a port number, and the port number is associated with the communication requirement. For example, when a port number “100” is associated with the “low delay” communication requirement, the application writes the port number “100” in the header of the transmission packet that requires “low delay.” As other examples, FQDN (Fully Qualified Domain Name) or URI (Uniform Resource Identifier) may be used as the identification information. The communication controller 13 is able to identify the communication requirement of the transmission packet based on the identification information included in the transmission packet.

In Step S30, the communication controller 13 selects a queue 12 for each transmission packet according to the communication requirement. The queue 12 selected here is hereinafter referred to as a “selection queue 12S.” At least one selection queue 12S is selected for one transmission packet. Depending on the communication requirement, two or more selection queues 12S may be selected simultaneously for one transmission packet. The communication controller 13 selects at least one selection queue 12S from the multiple types of queues 12 according to the communication requirement of the transmission packet.

A policy of selecting the selection queue 12S for each communication requirement is set in advance. Concrete examples of the policy of selecting the selection queue 12S for each communication requirement will be described later. Policy information 14 indicates the policy of selecting the selection queue 12S for each communication requirement. The policy information 14 is generated in advance and stored in a predetermined memory of the moving body 100. Based on the policy information 14, the communication controller 13 selects at least one selection queue 12S from the multiple types of queues 12 according to the communication requirement of the transmission packet.

In Step S40, the communication controller 13 stores (enqueues) the transmission packet in the selection queue 12S.

Each of the multiple types of communication interfaces 11 reads the transmission packet stored in the associated queue among the multiple types of queues 12 and transmits the read transmission packet to the external device 200. For example, the first communication interface 11-1 transmits the transmission packet stored in the first queue 12-1 based on the first communication method. The second communication interface 11-2 transmits the transmission packet stored in the second queue 12-2 based on the second communication method. It should be noted that simultaneous communication may be performed by the multiple types of communication methods.

The transmission packet is transmitted through the communication network 30 to the second communication device 20 of the external device 200. The network interface 21 of the second communication device 20 receives the packet and outputs the received packet to the communication controller 23. The communication controller 23 gathers the received packets received through various communication methods and outputs the received packets each to a destination application. The communication controller 23 may perform packet sequence control and/or discarding of duplicate packets. Alternatively, packet sequencing and discarding of duplicate packets may be done by TCP.

Processing of packet transmission from the external device 200 to the moving body 100 is as follows. At least one application of the external device 200 outputs a transmission packet to be transmitted to the mobile device 100. The communication controller 23 transmits the transmission packet to the moving body 100 (i.e., the first communication device 10) via the network interface 21. Here, the communication method on the side of the moving body 100 may be the same as or may be different from the communication method used in the packet transmission from the moving body 100 to the external device 200. The communication controller 23 may specify a communication method according to the communication requirement based on the same information as the policy information 14. When the second communication device 20 has the same queue configuration and interface configuration as the first communication device 10, the communication controller 23 may perform the same queuing process as the communication controller 13.

The transmission packet is transmitted through the communication network 30 to the first communication device 10 of the moving body 100. The communication controller 13 of the first communication device 10 receives the packet through the communication interface 11. The communication controller 13 gathers the received packets received through various communication methods and outputs the received packets each to a destination application.

### 1-4. Queuing Process According to Communication Requirement

As described above, the communication controller 13 of the first communication device 10 identifies the communication requirement for each transmission packet and performs the queuing process according to the communication requirement. The queuing process in cases of various communication requirements, that is, the policy of selecting the selection queue 12S will be described in detail below.

Here, for simplicity, a description will be given of a case of two types of communication methods, the first communication method and the second communication method (see FIG. 3). The same applies to a case of three or more types of communication methods. The communication cost of the first communication method is assumed to be lower than the communication cost of the second communication method. In other words, the communication cost of the second communication method is higher than the communication cost of the first communication method.

### 1-4-1. Standard

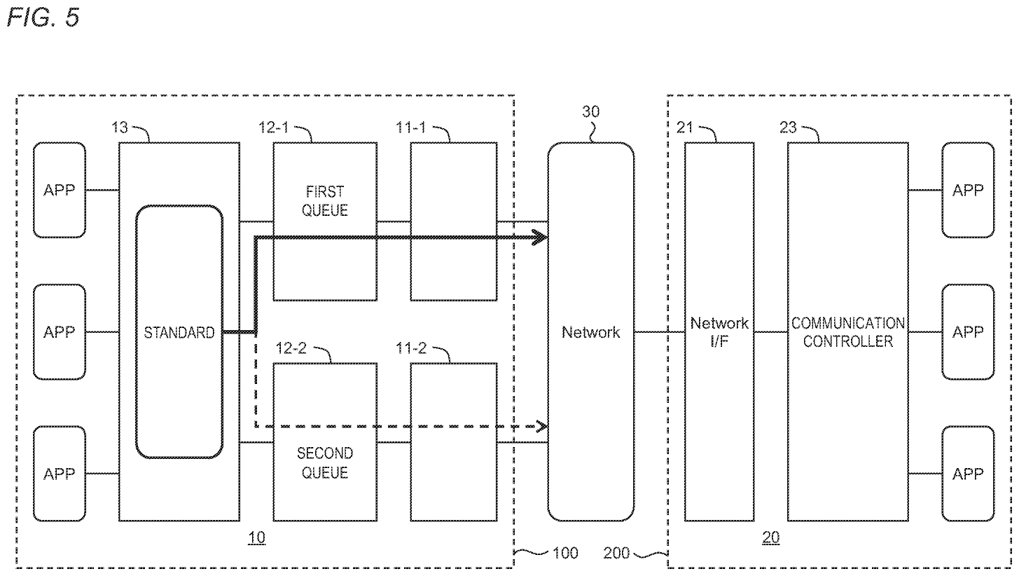

FIG. 5 is a conceptual diagram for explaining the queuing process in a case where the communication requirement is “standard.” The first queue 12-1 is associated with the first communication interface 11-1 that performs a communication based on the first communication method. On the other hand, the second queue 12-2 is associated with the second communication interface 11-2 that performs a communication based on the second communication method.

In the case where the communication requirement is “standard,” the communication controller 13 selects the first queue 12-1 as the selection queue 12S in preference to the second queue 12-2. That is, the communication controller 13 basically selects the first queue 12-1, but selects the second queue 12-2 when the first queue 12-1 becomes tight or unavailable.

For example, when a storage amount of the transmission packets in the first queue 12-1 is equal to or less than a threshold value (e.g., 80% of a capacity of the first queue 12-1), the communication controller 13 selects the first queue 12-1 as the selection queue 12S. On the other hand, when the storage amount of the transmission packets in the first queue 12-1 exceeds the threshold value, the communication controller 13 selects the second queue 12-2 as the selection queue 12S. As another example, when the moving body 100 is out of a communicable range of the first communication method, the first communication method becomes unavailable. When a time for which the first communication method is unavailable exceeds a certain period of time, the communication controller 13 selects the second queue 12-2 as the selection queue 12S.

As described above, when the communication requirement is “standard,” the first queue 12-1 is preferentially selected as the selection queue 12S. That is, the first communication method is preferentially used. As a result, the communication cost is suppressed.

### 1-4-2. Low Delay

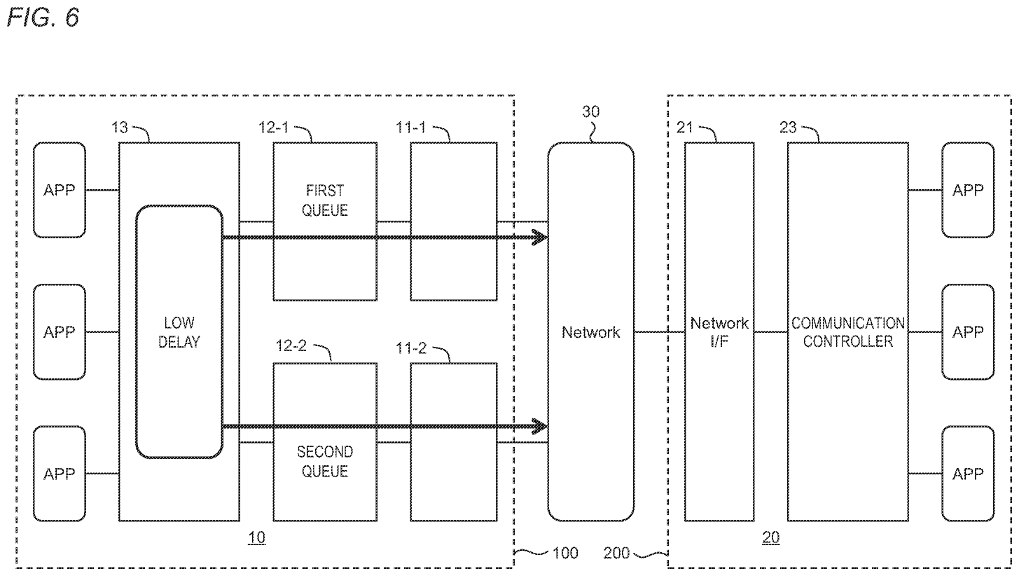

FIG. 6 is a conceptual diagram for explaining the queuing process in a case where the communication requirement is “low delay.” The “low delay” communication requirement requires a lower communication delay than the “standard” communication requirement described above.

In the case where the communication requirement is “low delay,” the communication controller 13 simultaneously selects both the first queue 12-1 and the second queue 12-2 as the selection queue 12S. Then, the communication controller 13 stores an identical transmission packet in both the first queue 12-1 and the second queue 12-2. The first communication interface 11-1 and the second communication interface 11-2 both transmit the identical transmission packet. The second communication device 20 adopts the packet that arrives earliest and discards the packet that arrives later.

Storing the identical transmission packet in both the first queue 12-1 and the second queue 12-2 as described above makes it possible to satisfy the “low delay” communication requirement.

### 1-4-3. High Throughput

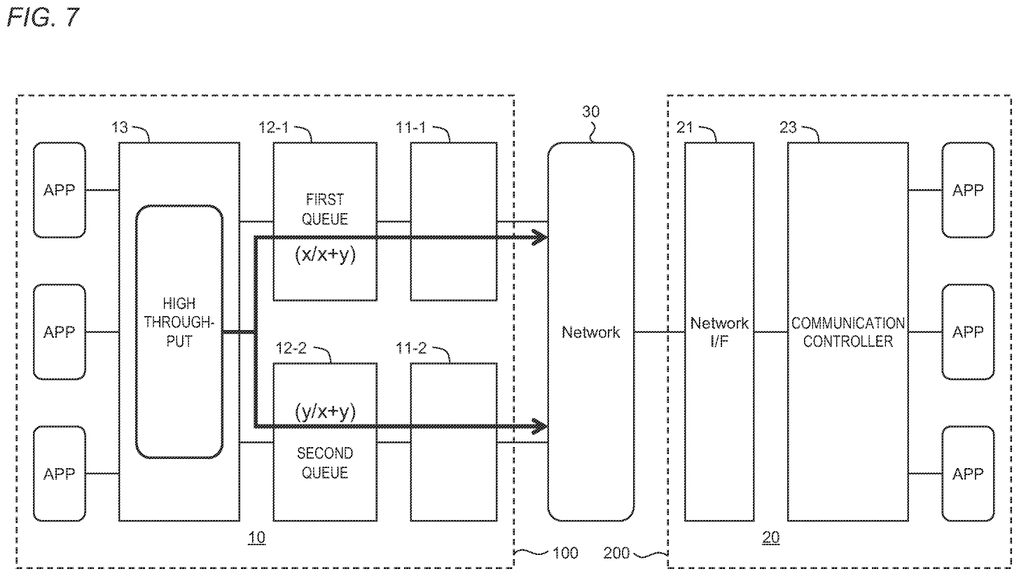

FIG. 7 is a conceptual diagram for explaining the queuing process in a case where the communication requirement is “high throughput.” The “high throughput” communication requirement requires a higher throughput than the “standard” communication requirement described above.

In the case where the communication requirement is “high throughput,” the communication controller 13 selects both the first queue 12-1 and the second queue 12-2 as the selection queue 12S. Then, the communication controller 13 distributes a plurality of transmission packets having the “high throughput” communication requirement to the first queue 12-1 and the second queue 12-2.

For example, the communication controller 13 acquires (measures or estimates) a throughput of the communication of the first communication method and a throughput of the communication of the second communication method. Various methods for measuring or estimating the throughput have been proposed. In the present embodiment, the measuring/estimating method is not limited in particular. The communication controller 13 distributes a plurality of transmission packets to the first queue 12-1 and the second queue 12-2 with a distribution ratio (weight) according to the throughput. For example, when the throughput of the first communication method is x [bps] and the throughput of the second communication method is y [bps], the distribution ratio is x:y. That is, the communication controller 13 stores the transmission packets of the first ratio x/(x+y) in the first queue 12-1 and stores the transmission packets of the second ratio y/(x+y) in the second queue 12-2.

Distributing a plurality of transmission packets to the first queue 12-1 and the second queue 12-2 as described above makes it possible to satisfy the “high throughput” communication requirement.

### 1-5. Concrete Example

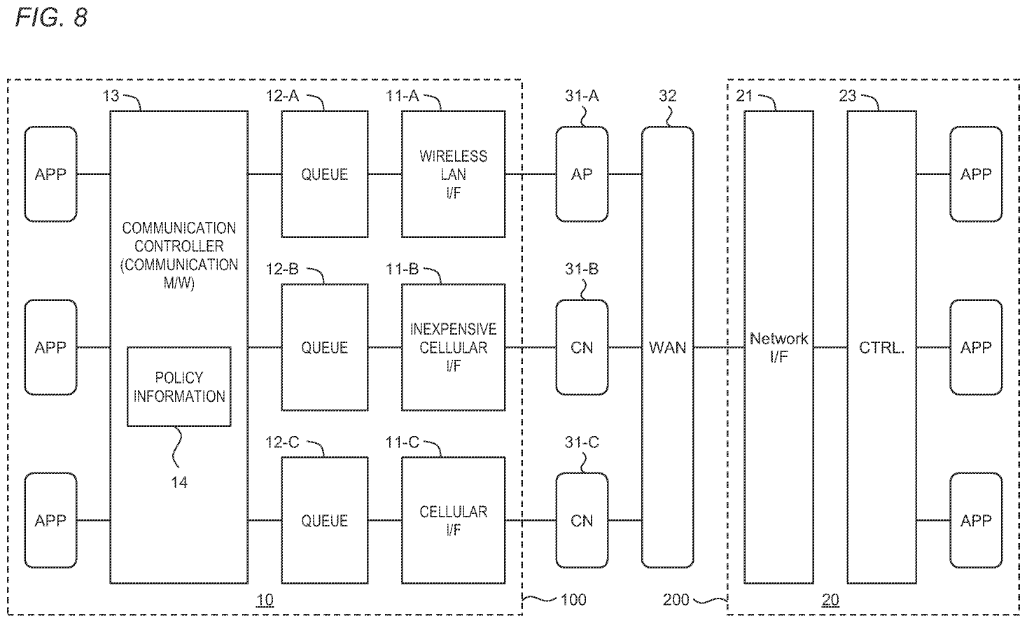

FIG. 8 is a block diagram showing a concrete example of the communication system 1 according to the present embodiment.

The multiple types of communication interfaces 11 of the first communication device 10 include a wireless LAN interface 11-A, an inexpensive cellular interface 11-B, and a cellular interface 11-C. The wireless LAN interface 11-A performs a communication based on a wireless LAN method (system). The wireless LAN interface 11-A is connected to a communication network 32 (e.g., a WAN) via an access point 31-A. The inexpensive cellular interface 11-B performs a communication based on an inexpensive cellular method (system) provided by MVNO. The inexpensive cellular interface 11-B is connected to the communication network 32 via a cellular network 31-B. The cellular interface 11-C performs a communication based on a common cellular method (system) provided by MNO. The cellular interface 11-C is connected to the communication network 32 via a cellular network 31-C. The communication cost is lower in the order of the wireless LAN method, the inexpensive cellular method, and the common cellular method.

A queue 12-A is associated with the wireless LAN interface 11-A and stores the transmission packet to be transmitted by the wireless LAN method. The wireless LAN interface 11-A transmits the transmission packet stored in the queue 12-A. A queue 12-B is associated with the inexpensive cellular interface 11-B and stores the transmission packet to be transmitted by the inexpensive cellular method. The inexpensive cellular interface 11-B transmits the transmission packet stored in the queue 12-B. A queue 12-C is associated with the cellular interface 11-C and stores the transmission packet to be transmitted by the common cellular method. The cellular interface 11-C transmits the transmission packet stored in the queue 12-C.

In the case where the communication requirement is “standard,” the communication controller 13 sets an order of priority and selects the selection queue 12S in accordance with the order of priority. The order of priority is set based on the communication cost. That is, the order of priority is in the order of the queues 12-A, 12-B, and 12-C. The communication controller 13 prioritizes the queue 12-A over the queue 12-B and prioritizes the queue 12-B over the queue 12-C. As a result, the communication cost is suppressed.

In the case where the communication requirement is “low delay,” the communication controller 13 simultaneously selects the queues 12-A, 12-B, and 12-C as the selection queue 125. Then, the communication controller 13 stores an identical transmission packet in the queues 12-A, 12-B, and 12-C. As a result, the “low delay” communication requirement is satisfied.

In the case where the communication requirement is “high throughput,” the communication controller 13 distributes a plurality of transmission packets to the queues 12-A, 12-B, and 12-C. For example, the communication controller 13 acquires the throughput of each communication method and distributes a plurality of transmission packets to the queues 12-A, 12-B, and 12-C with a distribution ratio (weight) according to the throughput. As a result, the “high throughput” communication requirement is satisfied.

### 1-6. Effects

According to the present embodiment, as described above, the multiple types of queues 12 associated with the multiple types of communication methods, respectively, are prepared. Then, for each transmission packet, the communication requirement is identified and the queuing process according to the communication requirement is performed. It is thus possible to achieve an appropriate communication for each transmission packet according to the communication requirement.

### 2. Second Embodiment

### 2-1. Configuration Example of Communication System

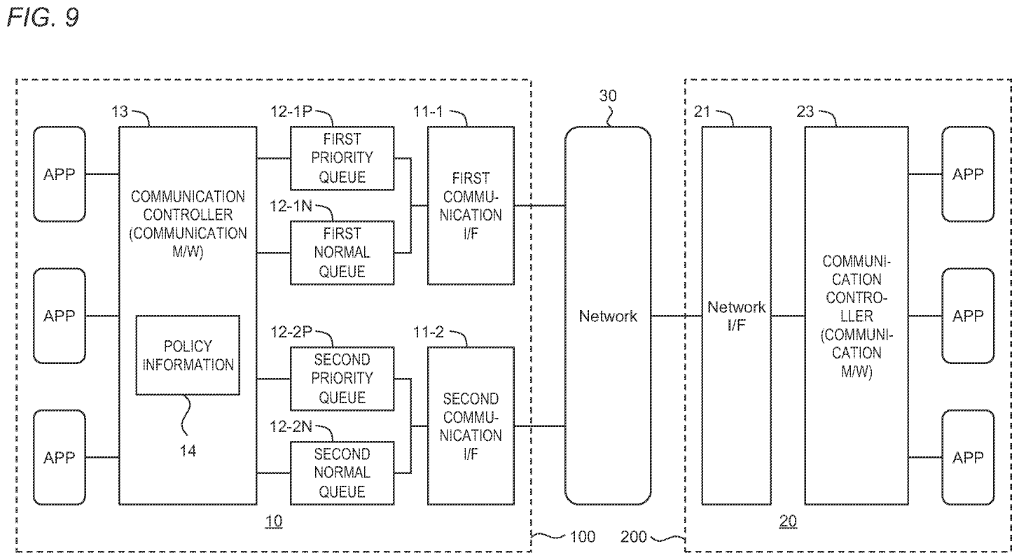

FIG. 9 is a block diagram showing a configuration example of the communication system 1 according to the second embodiment. An overlapping description with the case of the first embodiment will be omitted as appropriate.

In the second embodiment, two types of queues 12, a “priority queue” and a “normal queue,” are provided for each communication method. That is, each of the multiple types of queues 12 includes a “priority queue” and a “normal queue.” For example, the first queue 12-1 associated with the first communication method (i.e., the first communication interface 11-1) includes a first priority queue 12-1P and a first normal queue 12-1N. Similarly, the second queue 12-2 associated with the second communication method (i.e., the second communication interface 11-2) includes a second priority queue 12-2P and a second normal queue 12-2N.

The priority queue is higher in priority than the normal queue. In other words, the normal queue is lower in priority than the priority queue. When a transmission packet is stored in the priority queue, the transmission packet stored in the priority queue is read and transmitted even if another transmission packet is stored in the normal queue. A transmission packets stored in the normal queue is read and transmitted only when no transmission packet is stored in the priority queue.

For example, when a transmission packet is stored in the first priority queue 12-1P, the first communication interface 11-1 transmits the transmission packet stored in the first priority queue 12-1P. On the other hand, when no transmission packet is stored in the first priority queue 12-1P, the first communication interface 11-1 transmits a transmission packet stored in the first normal queue 12-1N. Similarly, when a transmission packet is stored in the second priority queue 12-2P, the second communication interface 11-2 transmits the transmission packet stored in the second priority queue 12-2P. On the other hand, when no transmission packet is stored in the second priority queue 12-2P, the second communication interface 11-2 transmits a transmission packet stored in the second normal queue 12-2N.

### 2-2. Queuing Process According to Communication Requirement

Hereinafter, the queuing process according to the communication requirement in the case of the second embodiment will be described. As in the case of the first embodiment, the communication cost of the first communication method is lower than the communication cost of the second communication method. In other words, the communication cost of the second communication method is higher than the communication cost of the first communication method.

### 2-2-1. Standard

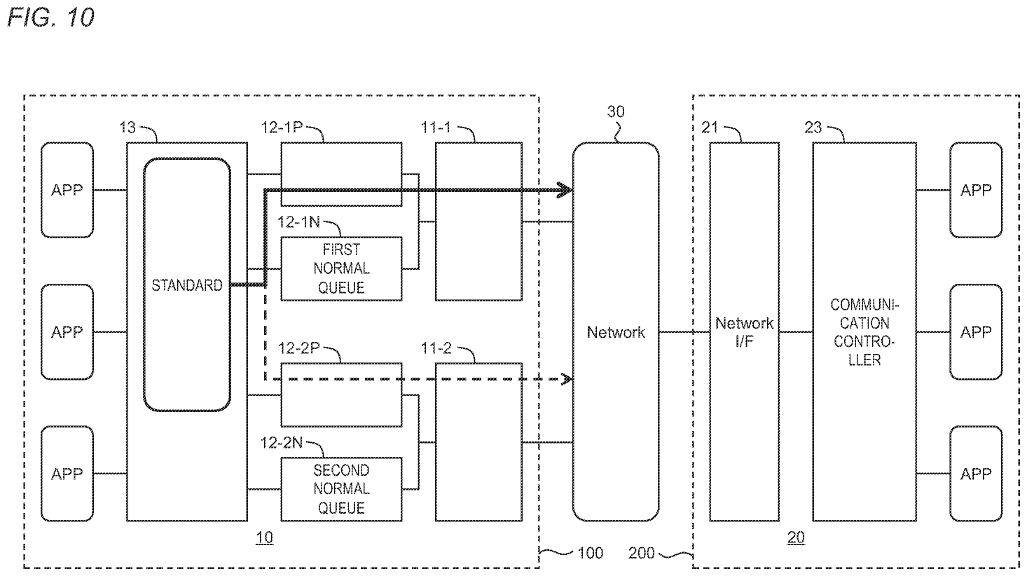

FIG. 10 is a conceptual diagram for explaining the queuing process in the case where the communication requirement is “standard.” The communication controller 13 selects the first priority queue 12-1P as the selection queue 12S in preference to the second priority queue 12-2P. That is, the communication controller 13 basically selects the first priority queue 12-1P, but selects the second priority queue 12-2P when the first priority queue 12-1P becomes tight or unavailable.

For example, when a storage amount of the transmission packets in the first priority queue 12-1P is equal to or less than a threshold value (e.g., 80% of a capacity of the first priority queue 12-1P), the communication controller 13 selects the first priority queue 12-1P as the selection queue 12S. On the other hand, when the storage amount of the transmission packets in the first priority queue 12-1P exceeds the threshold value, the communication controller 13 selects the second priority queue 12-2P as the selection queue 12S. As another example, when a time for which the first communication method is unavailable exceeds a certain period of time, the communication controller 13 selects the second priority queue 12-2P as the selection queue 12S.

As a result, the communication cost is suppressed. It should be noted that when the communication requirement is “standard,” the first normal queue 12-1N and the second normal queue 12-2N are not used.

### 2-2-2. Low Delay

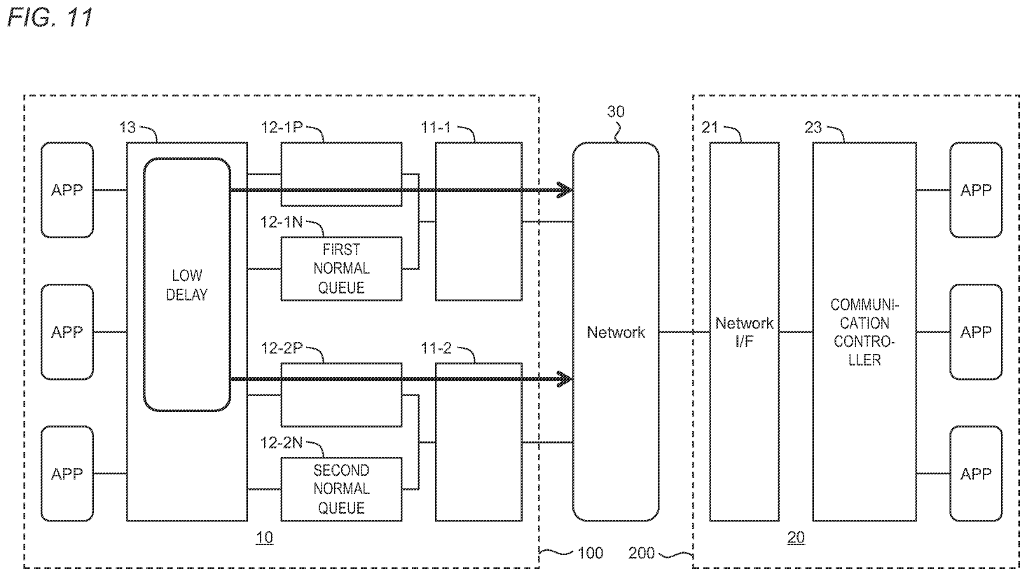

FIG. 11 is a conceptual diagram for explaining the queuing process in the case where the communication requirement is “low delay.” The communication controller 13 simultaneously selects both the first priority queue 12-1P and the second priority queue 12-2P as the selection queue 12S. Then, the communication controller 13 stores an identical transmission packet in both the first priority queue 12-1P and the second priority queue 12-2P. The first communication interface 11-1 and the second communication interface 11-2 both transmit the identical transmission packet. The second communication device 20 adopts the packet that arrives earliest and discards the packet that arrives later.

As a result, the “low delay” communication requirement is satisfied. It should be noted that when the communication requirement is “low delay,” the first normal queue 12-1N and the second normal queue 12-2N are not used.

### 2-2-3. High Throughput

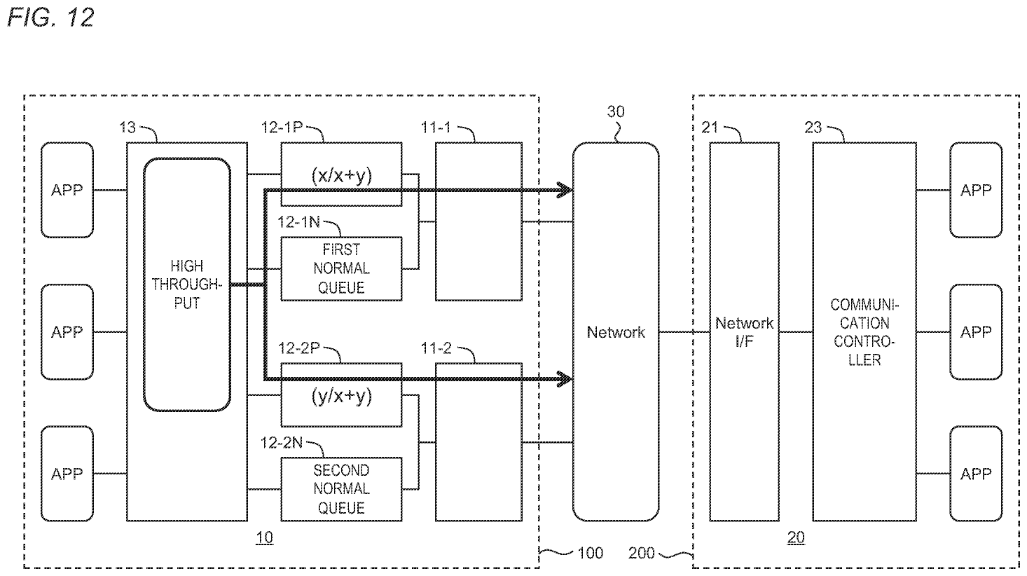

FIG. 12 is a conceptual diagram for explaining the queuing process in the case where the communication requirement is “high throughput.” The communication controller 13 selects both the first priority queue 12-1P and the second priority queue 12-2P as the selection queue 12S. Then, the communication controller 13 distributes a plurality of transmission packets having the “high throughput” communication requirement to the first priority queue 12-1P and the second priority queue 12-2P.

For example, the communication controller 13 acquires (measures or estimates) a throughput of the communication of the first communication method and a throughput of the communication of the second communication method. Then, the communication controller 13 distributes a plurality of transmission packets to the first priority queue 12-1P and the second priority queue 12-2P with a distribution ratio (weight) according to the throughput.

As a result, the “high throughput” communication requirement is satisfied. It should be noted that when the communication requirement is “high throughput,” the first normal queue 12-1N and the second normal queue 12-2N are not used.

### 2-2-4. Low Cost

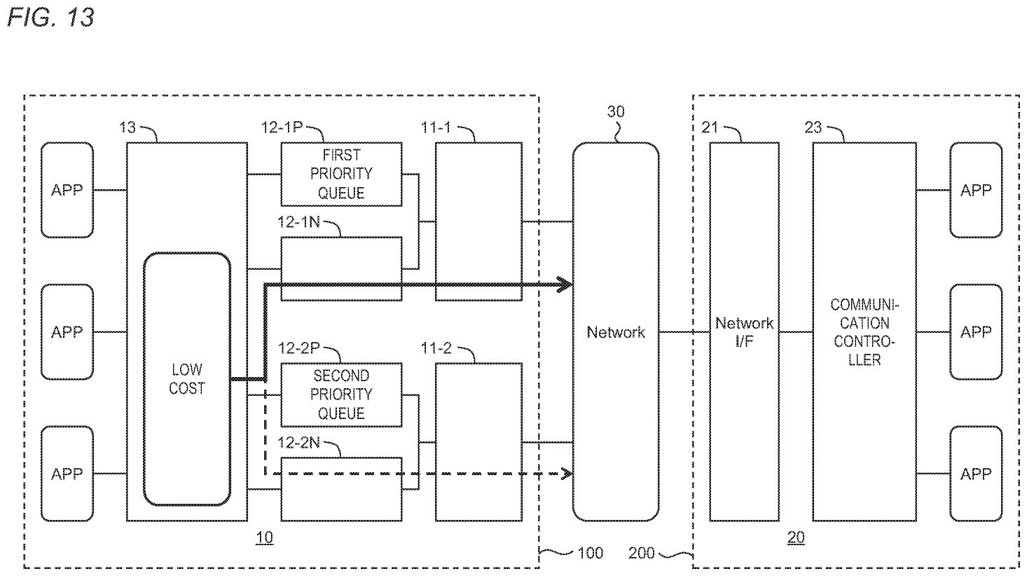

FIG. 13 is a conceptual diagram for explaining the queuing process in a case where the communication requirement is “low cost.” The “low cost” communication requirement requires a lower communication cost than the “standard” communication requirement.

When the communication requirement is “low cost,” the first priority queue 12-1P and the second priority queue 12-2P are not used. Instead, the first normal queue 12-1N and the second normal queue 12-2N are used. More specifically, the communication controller 13 selects the first normal queue 12-1N as the selection queue 12S in preference to the second normal queue 12-2N. That is, the communication controller 13 basically selects the first normal queue 12-1N, but selects the second normal queue 12-2N when the first normal queue 12-1N becomes tight or unavailable.

For example, when a storage amount of the transmission packets in the first normal queue 12-1N is equal to or less than a threshold value (e.g., 80% of a capacity of the first normal queue 12-1N), the communication controller 13 selects the first normal queue 12-1N as the selection queue 12S. On the other hand, when the storage amount of the transmission packets in the first normal queue 12-1N exceeds the threshold value, the communication controller 13 selects the second normal queue 12-2N as the selection queue 12S. As another example, when a time for which the first communication method is unavailable exceeds a certain period of time, the communication controller 13 selects the second normal queue 12-2N as the selection queue 12S.

As described above, when the communication requirement is “low cost,” the first normal queue 12-1N is preferentially selected as the selection queue 12S. That is, the first communication method is preferentially used. As a result, the “low cost” communication requirement is satisfied.

Furthermore, the transmission packet whose communication requirement is “low-cost” is stored not in the priority queue but in the normal queue. Therefore, the transmission packet having the “low-cost” communication requirement is prevented from interfering transmission of the transmission packets having other communication requirements (i.e., “standard,” “low-latency,” and “high-throughput”). That is, it is possible to satisfy the “low cost” communication requirement without deteriorating a communication efficiency of the transmission packets having the other communication requirements. When generalized, it is possible to deal with the multiple types of communication requirements by the same communication method without deteriorating the communication efficiency (communication performance).

### 2-3. Concrete Example

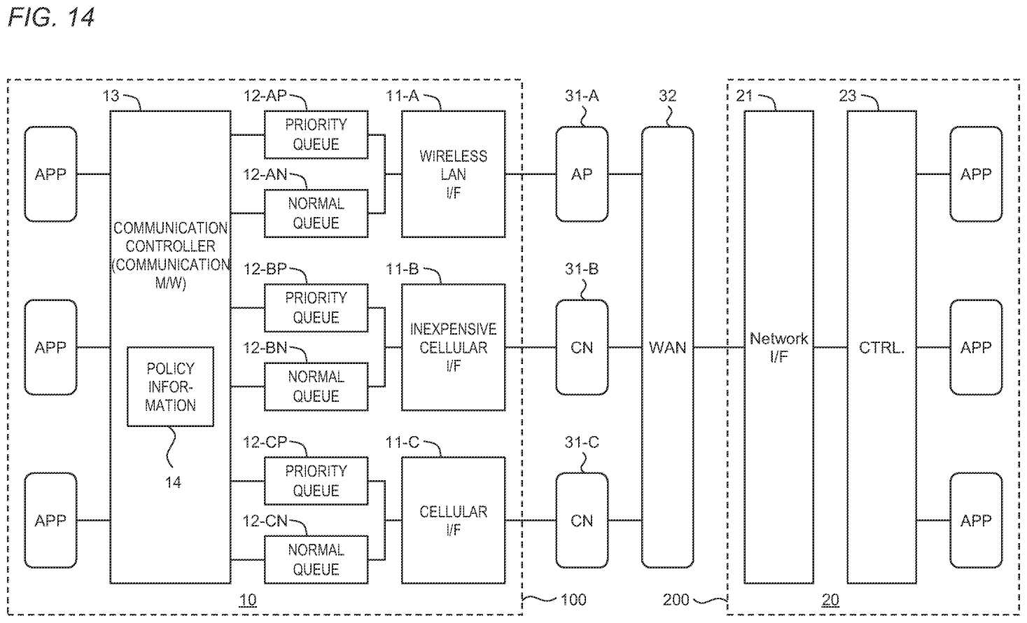

FIG. 14 is a block diagram showing a concrete example of the communication system 1 according to the present embodiment. An overlapping description with FIG. 8 will be omitted as appropriate.

The queue 12-A associated with the wireless LAN interface 11-A includes a priority queue 12-AP and a normal queue 12-AN. The queue 12-B associated with an inexpensive cellular interface 11-B includes a priority queue 12-BP and a normal queue 12-BN. The queue 12-C associated with the cellular interface 1I-C includes the priority queue 12-CP and the normal queue 12-CN.

In the case where the communication requirement is “standard,” the communication controller 13 sets an order of priority and selects the selection queue 12S in accordance with the order of priority. The order of priority is in the order of the priority queues 12-AP, 12-BP, and 12-CP. The communication controller 13 prioritizes the priority queue 12-AP over the priority queue 12-BP and prioritizes the priority queue 12-BP over the priority queue 12-CP. As a result, the communication cost is suppressed.

In the case where the communication requirement is “low delay,” the communication controller 13 simultaneously selects the priority queues 12-AP, 12-BP, and 12-CP as the selection queue 12S. Then, the communication controller 13 stores an identical transmission packet in the priority queues 12-AP, 12-BP, and 12-CP. As a result, the “low delay” communication requirement is satisfied.

In the case where the communication requirement is “high throughput,” the communication controller 13 distributes a plurality of transmission packets to the priority queues 12-AP, 12-BP, and 12-CP. For example, the communication controller 13 acquires the throughput of each communication method and distributes a plurality of transmission packets to the priority queues 12-AP, 12-BP, and 12-CP with a distribution ratio (weight) according to the throughput. As a result, the “high throughput” communication requirement is satisfied.

In the case where the communication requirement is “low cost,” the communication controller 13 sets an order of priority and selects the selection queue 12S in accordance with the order of priority. The order of priority is in the order of the normal queues 12-AN, 12-BN, and 12-CN. The communication controller 13 prioritizes the normal queue 12-AN over the normal queue 12-BN and prioritizes the normal queue 12-BN over the normal queue 12-CN. As a result, the “low cost” communication requirement is satisfied.

### 2-4. Effects

According to the second embodiment, the same effect as in the case of the first embodiment can be obtained. That is, it is possible to achieve an appropriate communication for each transmission packet according to the communication requirement. Moreover, the two types of queues 12, the “priority queue” and the “normal queue” are provided for each communication method. It is thus possible to simultaneously deal with the multiple types of communication requirements by the same communication method without deteriorating the communication efficiency (communication performance).

What is claimed is:

1. A communication device installed on a moving body, the communication device comprising:
multiple types of communication interfaces configured to perform communications based on multiple types of communication methods, respectively;
multiple types of queues associated with the multiple types of communication interfaces, respectively; and
a communication controller provided between at least one application and the multiple types of queues, wherein
each of the multiple types of communication interfaces is configured to transmit a packet stored in an associated queue among the multiple types of queues to an external device, and
the communication controller is configured to:
receive a transmission packet to be transmitted to the external device from the at least one application;
identify a communication requirement for each transmission packet;
select at least one selection queue for each transmission packet among the multiple types of queues according to the communication requirement; and
store the transmission packet in the at least one selection queue.

2. The communication device according to claim 1, wherein
each of the multiple types of queues includes a priority queue and a normal queue whose priority is lower than that of the priority queue, and
each of the multiple types of communication interfaces is further configured to:
when the transmission packet is stored in the priority queue, transmit the transmission packet stored in the priority queue; and
when no transmission packet is stored in the priority queue, transmit the transmission packet stored in the normal queue.

3. The communication device according to claim 1, wherein
the multiple types of communication methods include:
a first communication method; and
a second communication method whose communication cost is higher than that of the first communication method,
the multiple types of communication interfaces include:
a first communication interface configured to perform a communication based on the first communication method; and
a second communication interface configured to perform a communication based on the second communication method,
the multiple types of queues include:
a first queue associated with the first communication interface; and
a second queue associated with the second communication interface, and
when the communication requirement is a standard communication requirement, the communication controller is further configured to select the first queue in preference to the second queue as the selection queue.

4. The communication device according to claim 3, wherein
when the communication requirement requires a lower delay than the standard communication requirement, the communication controller is further configured to select both the first queue and the second queue as the selection queue and to store an identical transmission packet in both the first queue and the second queue.

5. The communication device according to claim 3, wherein
when the communication requirement requires a higher throughput than the standard communication requirement, the communication controller is further configured to select both the first queue and the second queue as the selection queue and to distribute a plurality of transmission packets to the first queue and the second queue.

6. The communication device according to claim 3, wherein
the first queue includes a first priority queue and a first normal queue whose priority is lower than that of the first priority queue,
the second queue includes a second priority queue and a second normal queue whose priority is lower than the second priority queue,
the first communication interface is further configured to:
when the transmission packet is stored in the first priority queue, transmit the transmission packet stored in the first priority queue; and
when no transmission packet is stored in the first priority queue, transmit the transmission packet stored in the first normal queue,
the second communication interface is further configured to:
when the transmission packet is stored in the second priority queue, transmit the transmission packet stored in the second priority queue; and
when no transmission packet is stored in the second priority queue, transmit the transmission packet stored in the second normal queue, and
when the communication requirement is the standard communication requirement, the communication controller is further configured to select the first priority queue in preference to the second priority queue as the selection queue.

7. The communication device according to claim 6, wherein
when the communication requirement requires a lower cost than the standard communication requirement, the communication controller is further configured to select the first normal queue in preference to the second normal queue as the selection queue without using the first priority queue and the second priority queue.

8. The communication device according to claim 6, wherein
when the communication requirement requires a lower delay than the standard communication requirement, the communication controller is further configured to select both the first priority queue and the second priority queue as the selection queue and to store an identical transmission packet in both the first priority queue and the second priority queue.

9. The communication device according to claim 6, wherein
when the communication requirement requires a higher throughput than the standard communication requirement, the communication controller is further configured to select both the first priority queue and the second priority queue as the selection queue and to distribute a plurality of transmission packets to the first priority queue and the second priority queue.

10. The communication device according to claim 1, wherein
the communication controller is further configured to select the at least one selection queue among the multiple types of queues according to the communication requirement, based on policy information indicating a policy of selecting the selection queue for each communication requirement.

11. A non-transitory computer-readable recording medium on which communication middleware applied to a communication device installed on a moving body is recorded,
the communication device comprising:
multiple types of communication interfaces configured to perform communications based on multiple types of communication methods, respectively; and
multiple types of queues associated with the multiple types of communication interfaces, respectively, wherein
each of the multiple types of communication interfaces is configured to transmit a packet stored in an associated queue among the multiple types of queues to an external device,
the communication middleware being configured to execute, when executed by a computer, a queuing process comprising:
receiving a transmission packet to be transmitted to the external device from at least one application;
identifying a communication requirement for each transmission packet;
selecting at least one selection queue for each transmission packet among the multiple types of queues according to the communication requirement; and
storing the transmission packet in the at least one selection queue.

12. A communication system comprising:
a first communication device installed on a moving body; and
a second communication device connected to the first communication device through a communication network, wherein
the first communication device comprises:
multiple types of communication interfaces configured to perform communications based on multiple types of communication methods, respectively;
multiple types of queues associated with the multiple types of communication interfaces, respectively; and
a communication controller provided between at least one application and the multiple types of queues, wherein
each of the multiple types of communication interfaces is configured to transmit a packet stored in an associated queue among the multiple types of queues to the second communication device, and
the communication controller is configured to:
receive a transmission packet to be transmitted to the second communication device from the at least one application;
identify a communication requirement for each transmission packet;
select at least one selection queue for each transmission packet among the multiple types of queues according to the communication requirement; and
store the transmission packet in the at least one selection queue.
